(19) United States
(12) Patent Application Publication
(10) Pub. No.: US 2009/0266935 A1
(43) Pub. Date: Oct. 29, 2009

(54) SHELL ARRANGEMENT AS WELL AS AIRCRAFT OR SPACECRAFT

(76) Inventor: Paul Joern, Hamburg (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/416,519

(22) Filed: Apr. 1, 2009

Related U.S. Application Data
(60) Provisional application No. 61/125,746, filed on Apr. 28, 2008.

(51) Int. Cl. B64D 45/02; H05F 3/00

(52) U.S. Cl. 244/1 A; 361/218

(57) ABSTRACT

The present invention provides a shell arrangement as well as an aircraft or spacecraft comprising such a shell arrangement. The shell arrangement comprises a first lightning conductor layer for conducting lightning energy and a fibre composite layer supporting the first lightning conductor layer. Furthermore, the shell arrangement comprises a first electrical connection for connecting a first electrical component with the first lightning conductor layer. The advantage resulting according to the invention is that the lightning conductor layer fulfils a double function: on the one hand it serves to conduct lightning energy and on the other hand it forms a portion of a circuit for operating the first electrical component. For this reason, the need for electrical wiring in the airplane is reduced, in turn resulting in a weight reduction for the aircraft or spacecraft.

### CROSS-REFERENCE TO RELATED APPLICATIONS

This application claims the benefit of U.S. Provisional Application No. 61/125,746, filed Apr. 28, 2008 the entire disclosure of which is herein incorporated by reference.

### FIELD OF THE INVENTION

The present invention relates to a shell arrangement for an aircraft or spacecraft as well as to an aircraft or spacecraft comprising such a shell arrangement.

### BACKGROUND OF THE INVENTION

In particular airplanes are increasingly formed with shell arrangements comprising a carbon fibre reinforced plastic (CFRP). Because of the low electrical conductivity of CFRP compared to metal, such shell arrangements have to be provided with a lightning conductor material, as for example described in DE 10 2006 046 002 A1.

Furthermore, in airplanes it is required to connect electrical components provided in the airplane to ground. Hitherto, this is achieved in that separate metallic conductors are built in the airplanes and are connected to the respective ground connections of the components.

In this approach it has proven to be disadvantageous that the separate metallic conductors, which are built in, increase the weight of the airplane. In addition, the installation expenses for these conductors are considerable.

### SUMMARY OF THE INVENTION

Therefore, the object of the present invention is to remove the disadvantages described above.

Said object is achieved by a shell arrangement having the features of patent claim 1 and/or by an aircraft or spacecraft having the features of patent claim 6.

Accordingly, a shell arrangement for an aircraft or spacecraft is provided. Said shell arrangement comprises a first lightning conductor layer for conducting lightning energy and a fibre composite layer supporting said first lightning conductor layer. Furthermore, the shell arrangement is provided with a first electrical connection for connecting a first electrical component with the first lightning conductor layer.

Furthermore, an aircraft or spacecraft comprising the shell according to the invention as well as a first electrical component connected to the first electrical connection of the shell arrangement according to the invention is provided. The idea underlying the present invention is that a double function is imposed on the first lightning conductor layer: on the one hand it serves to conduct lightning energy and on the other hand it serves as ground connection for electrical components. Because the lightning conductor layer, for example, substantially covers the whole fuselage, from now on comparatively short electrical conductors have to be provided between the ground connections of the components and the ground, leading to a considerable weight reduction. In addition, it is no longer necessary to install long conductors in the airplane, whereby the installation expenses are further reduced.

Advantageous embodiments and improvements of the invention result from the dependent claims.

In the present document “components” are meant to be in particular power consumers and power sources.

According to a preferred further embodiment of the shell arrangement according to the invention, an insulation layer and a second lightning conductor layer are provided between the first lightning conductor layer and the fibre composite layer so that the order of first lightning conductor layer, insulation layer, second lightning conductor layer, fibre composite layer results, wherein a second electrical connection for connecting the second lightning conductor layer with a second electrical component is provided. Thus, the first and second lightning conductor layer may form grounds having different electrical potentials. This may be favourable for different types of components.

According to a preferred further embodiment, the fibre composite layer comprises CFRP. The CFRP preferably comprises a matrix system having high insulation properties compared to the first and second lightning conductor layer respectively.

According to a preferred further embodiment of the shell arrangement according to the invention, the first and/or second lightning conductor layer is locally thickened for an improved conductivity, in particular in the area of the first or second connection.

According to another preferred further embodiment of the shell arrangement according to the invention, the first and/or second lightning conductor layer comprises a metallic tissue, a metal foil, particularly a perforated or slotted metal foil, and/or a nonwoven.

According to another preferred further embodiment of the aircraft or spacecraft according to the invention, a second electrical component is provided, which is connected to the second electrical connection of the shell arrangement. The advantages resulting in conjunction with this were already explained above.

According to another preferred further embodiment of the aircraft or spacecraft according to the invention, the first and/or second lightning conductor layer is arranged on the outside with regard to the fibre composite layer and the first and/or second component is arranged on the inside with regard to the fibre composite layer. Thus, the first and second lightning conductor layer effectively protect both the fibre composite layer and the components from a stroke of lightning.

### BRIEF DESCRIPTION OF THE DRAWINGS

The invention is described in more detail below by means of embodiments with respect to the accompanying drawings, in which:

FIG. 1 schematically shows a section of an aircraft or spacecraft according to an embodiment of the present invention; and

FIG. 2 schematically shows a section of an aircraft or spacecraft according to another embodiment of the invention.

In the figures same reference numbers denote the same or analogue components, unless stated to the contrary.

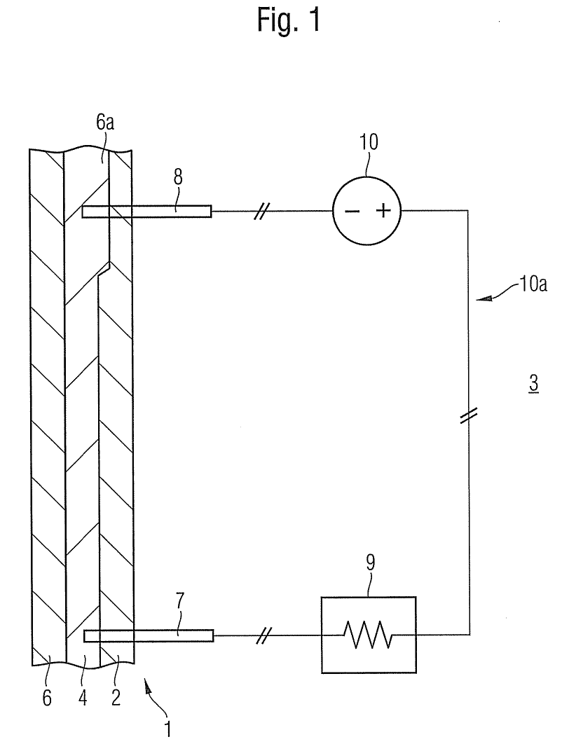

FIG. 1 schematically shows a section of an aircraft or spacecraft according to an embodiment of the present invention.

### DETAILED DESCRIPTION OF THE DRAWINGS

FIG. 1 shows a shell arrangement 1, in particular of a fuselage of an airplane. The shell arrangement 1 comprises a fibre composite layer 2 substantially forming a supporting structure of the aircraft or spacecraft. With respect to an interior space 3 of the aircraft or spacecraft, the fibre composite layer 2 supports a first lightning conductor layer 4 on the outside. With respect to a schematically indicated environment 5, the lightning conductor layer 4 is preferably provided in a protected manner by means of a coat of lacquer.

Two connections 7 and 8 extend from the interior space 3 through the fibre composite layer 2. The connections 7, 8 are respectively connected at their one end with the first lightning conductor layer 4. In addition, the lightning conductor layer 4 may be locally thickened for an improved conductivity, as, for example, illustrated for the connection 8. Said thickening is designated by the reference number Ga. Alternatively or additionally, the end of the connection 8 connected to the first lightning conductor layer 4, for example, may be flat in order to ensure an improved conductivity between the connection 8 and the lightning conductor layer 4.

Of course, said connections 7 and 8 should be provided in a manner electrically insulated with respect to the layer 2.

At its other end, the connection 7 is electroconductively connected to a consumer 9, for example a light source. In the figures the electric cables are illustrated by means of a line crossed out twice.

In turn, the consumer 9 is connected to a power source 10, for example a generator, by means of an electric cable. The power source 10 is in turn electrically connected to the other end of the connection 8.

Thus, as shown in FIG. 1, a closed circuit 10a results, wherein the first lightning conductor layer 4 functions as ground and the first lightning conductor layer 4 forms a portion of the circuit 10a respectively.

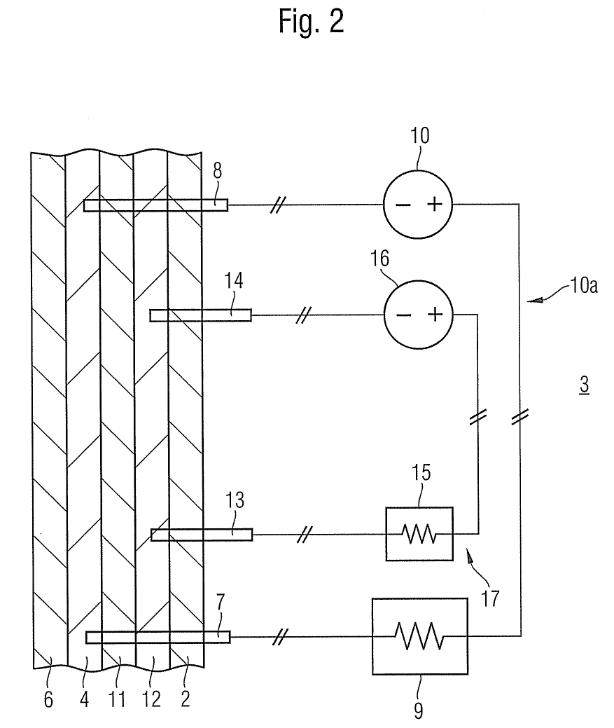

FIG. 2 schematically shows a section of an aircraft or spacecraft according to a further embodiment of the present invention.

In addition, the embodiment according to FIG. 2 is based on the embodiment according to FIG. 1. In this respect, only the differences between the embodiments will be discussed below.

Compared with the embodiment according to FIG. 1, the embodiment according to FIG. 2 further comprises an insulation layer 11 and a second lightning conductor layer 12 between the first lightning conductor layer 4 and the fibre composite layer 2.

The second lightning conductor layer 12 forms a portion of a second circuit 17. The second circuit 17 is composed of the connections 13 and 14, a consumer 15 and a power source 16 and is configured in accordance with the circuit already explained in conjunction with FIG. 1.

The circuits 10a and 17 can be operated in a state electrically insulated from each other. In particular, it can be intended that the reference potential of the grounds 4 and 12 are provided differently. Thus, it can particularly be avoided that the circuits 10a and 17 interfere each other.

Of course, in FIG. 2 the connections 7 and 8 should be provided in a manner electrically insulated with respect to the layers 2, 12 and 11. Of course, the connections 13 and 14 should also be provided in a manner electrically insulated with respect to the layer 2. For example, this may be achieved in that the CFRP is formed with an insulating matrix system.

Of course, any number of consumers 9 and 15 respectively and power sources 10 and 16 respectively may be integrated in the embodiments according to FIG. 1 and according to FIG. 2 respectively.

The fibre composite layer 2 preferably comprises a CFRP. The first and second lightning conductor layer 4, 12 are preferably formed of a metallic tissue or a metal foil.

In the present invention, the lightning conductor layers 4, 12 do not necessarily have to be connected to the ground connections of the components 9, 10, 15, 16, they rather may also form a reference potential for other electrical connections of the components.

Although the present invention has been described by means of preferred embodiments, it is not limited thereto, but may be modified in a manifold manner.

The present invention provides a shell arrangement as well as an aircraft or spacecraft comprising such a shell arrangement. The shell arrangement comprises a first lightning conductor layer for conducting lightning energy and a fibre composite layer supporting the first lightning conductor layer. Furthermore, the shell arrangement comprises a first electrical connection for connecting a first electrical component with a first lightning conductor layer. The advantage resulting in accordance with the invention is that the lightning conductor layer fulfils a double function: on the one hand it serves to conduct lightning energy and on the other hand it forms a portion of a circuit for operating the first electrical component. For this reason, the need for electrical wiring in the airplane is reduced, in turn resulting in a weight reduction for the aircraft or spacecraft.

1. Shell arrangement for an aircraft or spacecraft comprising:
a first lightning conductor layer for conducting lightning energy; and
a fibre composite layer supporting said first lightning conductor layer;
wherein a first electrical connection for connecting a first electrical component with said first lightning conductor layer is provided,
characterized in that
an insulation layer and a second lightning conductor layer are provided between said first lightning conductor layer and said fibre composite layer so that the order of first lightning conductor layer, insulation layer, second lightning conductor layer, fibre composite layer results, wherein a second electrical connection for connecting said second lightning conductor layer with a second electrical component is provided.

2. Shell arrangement according to claim 1,
wherein said first and/or second lightning conductor layer is thickened in the area of said first and/or second connection.

3. Shell arrangement according to claim 1,
wherein said first and/or second lightning conductor layer comprises a metallic tissue, a metal foil, in particular a perforated or slotted metal foil, and/or a nonwoven.

4. Shell arrangement according to claim 1,
wherein said first and/or second electrical connection is formed as ground connection.

5. Aircraft or spacecraft comprising:
a shell arrangement according to one of the preceding claims; and
a first electrical component connected to said first electrical connection of said shell arrangement.

6. Aircraft or spacecraft according to claim 5,
wherein a second electrical component connected to said second electrical connection is provided.

7. Aircraft or spacecraft according to claim 6,
wherein said first and/or second lightning conductor layer is arranged on the outside with regard to said fibre composite layer and said first and/or second component is arranged on the inside with regard to the fibre composite layer.

8. Aircraft or spacecraft according to claim 6,
wherein said first electrical component is connected by its ground connection to said first electrical connection and/or said second electrical component is connected by its ground connection to said second electrical connection.

9. Aircraft or spacecraft according to claim 6,
wherein said first electrical component forms a first circuit with said first lightning conductor layer and/or said second electrical component forms a second circuit with said second lightning conductor layer.
